(19) United States
(12) Patent Application Publication
(10) Pub. No.: US 2009/0168005 A1
(43) Pub. Date: Jul. 2, 2009

(54) LIQUID CRYSTAL DISPLAY

(76) Inventors: Kwang-hyun Kim, Guri-si (KR); Jeong-uk Heo, Seongnam-si (KR); Kyong-ok Park, Bucheon-si (KR); Nam-seok Lee, Suwon-si (KR); Ho-yun Byun, Hwaseong-si (KR); Sung-hwan Hong, Suwon-si (KR); Jung-hun Lee, Seoul (KR); Ji-yoon Jung, Cheonan-si (KR)

Correspondence Address: Haynes and Boone, LLP;IP Section, 2323 Victory Avenue, SUITE 700, Dallas, TX, 75219, US

(21) Appl. No.: 12/187,133

(22) Filed: Aug. 6, 2008

(30) Foreign Application Priority Data
Dec. 28, 2007 (KR) 10-2007-0140253

(51) Int. Cl. G02F 1/1343

(52) U.S. Cl. 349/144

(57) ABSTRACT

A liquid crystal display according to an embodiment includes a first substrate, a pixel electrode, which is formed on the first substrate comprises a first domain dividing means, a first sub pixel electrode and a second sub pixel electrode which are distanced from each other to have a predetermined interval, a second substrate which is disposed to face the first substrate, a second domain dividing means which is formed on the second substrate; and a liquid crystal layer which is interposed between the first substrate and the second substrate, wherein a plurality of sub areas are defined by the first and second domain dividing means, and a width of a sub area of the first sub pixel electrode and a width of a sub area of the second sub pixel electrode are different.

### CROSS-REFERENCE TO RELATED APPLICATION

This application claims priority to and benefit from Korean Patent Application No. 10-2007-0140253, filed on Dec. 28, 2007 in the Korean Intellectual Property Office, the disclosure of which is incorporated herein by reference in its entirety.

### BACKGROUND

1. Technical Field

The present invention generally relate to a liquid crystal display having a vertical alignment (VA) mode driving type.

2. Description of the Related Art

The VA mode, and especially, a patterned vertical alignment (PVA) mode driving type provides a pattern having a cutout to an electrode on upper and lower substrates of a liquid crystal panel of a liquid crystal display to generate a fringed field to adjust an alignment of a liquid crystal molecule. The VA (or PVA) mode provides a driving mode in which a liquid crystal molecule is vertically aligned to an alignment layer when an electric field is not applied, and the major axis of the liquid crystal molecule has a negative dielectric anisotropy vertically formed to the electric field when the electric field is applied, thereby adjusting light transmittance.

In this PVA mode, an interval between electrodes of a domain to which the electric field is formed is restricted to approximately 24 um, and the transmittance increases because of a decrease of the cutout for a bigger interval. However, it is difficult to control a dynamic texture generated due to non-uniformity of an inclined direction of the liquid crystal molecule, and accordingly, the response speed decreases.

To solve this problem, a minute comb pattern may be formed on the electrode forming the fringed field to increase the interval between the electrodes. However, it is difficult to form this minute electrode pattern, which may result in a yield decrease.

### SUMMARY

The foregoing and/or one or more other embodiments of the present invention can be achieved by providing a liquid crystal display, including a first substrate, a pixel electrode, which is formed on the first substrate, comprises a first domain dividing means, a first sub pixel electrode and a second sub pixel electrode which are distanced from each other to have a predetermined interval, a second substrate which is disposed to face the first substrate, a second domain dividing means which is formed on the second substrate, and a liquid crystal layer which is interposed between the first substrate and the second substrate, wherein a plurality of sub areas are defined by the first and second domain dividing means, and a width of a sub area of the first sub pixel electrode and a width of a sub area of the second sub pixel electrode are different. The liquid crystal layer may include a chiral dopant. The pitch of a liquid crystal molecular which may includes the chiral dopant may be more than 20 μm, for example. The different data voltages may be applied to the first sub pixel electrode and the second sub pixel electrode. A higher data voltage may be applied to the first sub pixel electrode than the second sub pixel electrode.

The liquid crystal display in accordance with an embodiment may further include a first gate line and a second gate line which are formed on the first substrate adjacent to each other, a data line which is insulated from the gate lines, and crosses the gate lines, a first thin film transistor to which the first gate line and the data line are electrically connected, and a second thin film transistor to which the second gate line and the data line are electrically connected, wherein a time-divided gate on voltage is applied to the first gate line and the second gate line.

The liquid crystal display in accordance with an embodiment may further include a gate line which is formed on the first substrate, a first data line and a second data line which are insulated from the gate line, cross the gate line, and are adjacent to each other, a first thin film transistor to which the gate line and the first data line are electrically connected, and a second thin film transistor to which the gate line and the second data line are electrically connected, wherein different data voltages are applied to the first and second data lines when a gate on voltage is applied to the gate line.

The first sub pixel electrode and the second sub pixel electrode may form a capacitive coupling. The width of the sub area of the first sub pixel electrode may be smaller than the width of the sub area of the second sub pixel electrode. A width ratio of the first sub pixel electrode and the second sub pixel electrode may be about 1:1.2 to 1:2.7, for example. The width of the first sub pixel electrode may be approximately 15 to 24 μm. The width of the second sub pixel electrode may be approximately 28 to 40 μm.

The pitch of the liquid crystal molecular, which may include the chiral dopant, may be more than approximately 20 μm when the width of the sub area of the first sub pixel electrode is more than approximately 20 μm.

The pitch of the liquid crystal molecular which may include the chiral dopant may be more than about 40 μm when the width of the sub area of the first sub pixel electrode is less than about 20 μm.

The area of the second sub pixel electrode may be bigger than the area of the first sub pixel electrode. The ratio of the area of the first sub pixel electrode and the area of the second sub pixel electrode may be approximately 1:1.5 to 1:2.5.

### BRIEF DESCRIPTION OF THE DRAWINGS

These and/or other embodiments of the present invention will become apparent and more readily appreciated from the following description of the exemplary embodiments, taken in conjunction with the accompanying drawings, in which:

FIG. 1 is a block diagram of a liquid crystal display according to an exemplary embodiment of the present invention;

FIG. 2 is an equivalent circuit diagram of two sub pixels of the liquid crystal display according to the exemplary embodiment of the present invention;

FIG. 3 is an equivalent circuit diagram of a pixel of a liquid crystal display panel assembly according to the exemplary embodiment of the present invention;

FIG. 4 is an arrangement diagram of the liquid crystal display panel assembly according to the exemplary embodiment of the present invention;

FIGS. 5 and 6 are sectional views of the liquid crystal display panel assembly illustrated in FIG. 4 taken along lines V-V and VI-VI, respectively;

FIG. 7 is an arrangement diagram of a pixel electrode and a common electrode in the liquid crystal display panel assembly according to the exemplary embodiment of the present invention; and

FIGS. 8A to 8C are plane views of an electrode piece which is a basis of each sub pixel electrode illustrated in FIG. 7;

FIGS. 9 and 10 are arrangement diagrams of a pixel electrode and a common electrode of a liquid crystal display panel assembly according to an exemplary embodiment of the present invention; and

FIG. 11 is a gamma curve of each gray scale voltage according to an exemplary embodiment of the present invention.

### DETAILED DESCRIPTION

Reference will now be made in detail to the embodiments of the present invention, examples of which are illustrated in the accompanying drawings, wherein like reference numerals refer to like elements throughout. In the accompanying drawings, thicknesses may be enlarged to clearly illustrate various layers and areas. That a first unit such as a layer, an area, a substrate, etc. is provided ‘on’ a second unit may mean that the first unit is provided directly on the second unit, or that a third unit is provided therebetween. Also, that a first unit is provided ‘directly on’ a second unit may mean that there is nothing therebetween.

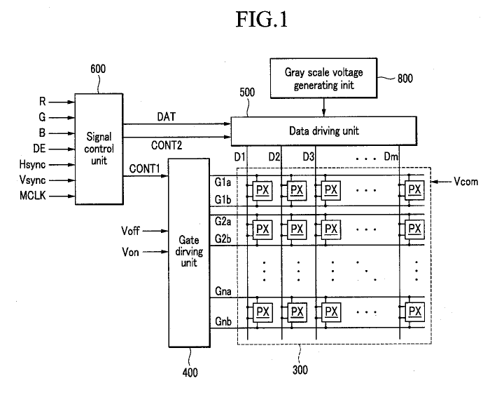

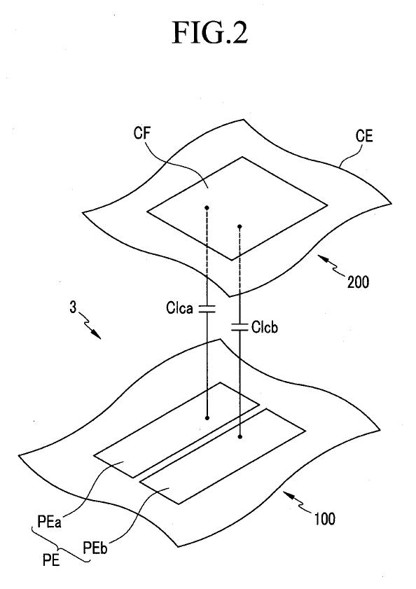

At first, a liquid crystal display device according to an exemplary embodiment of the present invention will be described by referring to FIGS. 1 and 2.

FIG. 1 is a block diagram of a liquid crystal display according to an exemplary embodiment of the present invention, and FIG. 2 is an equivalent circuit diagram of two sub pixels of the liquid crystal display according to the exemplary embodiment of the present invention.

As shown in FIG. 1, the liquid crystal display according to the exemplary embodiment of the present invention includes a liquid crystal display panel assembly 300, a gate driving unit 400 and a data driving unit 500 connected thereto, a gray scale voltage generating unit 800 connected to the data driving unit 500, and a signal control unit 600 controlling these.

The liquid crystal display panel assembly 300 includes a plurality of signal lines G₁ₐ-G_{nb} (also referred to as “gate lines”) and D₁-Dₘ (also referred to as “data lines”), and a plurality of pixels PX connected thereto and arranged in an approximately matrix shape in an equivalent circuit diagram thereof. As shown in FIG. 2, the liquid crystal display panel assembly 300 includes lower and upper display substrates 100 and 200 facing each other, and a liquid crystal layer 3 interposed therebetween.

The signal lines (shown in FIG. 1) include a plurality of gate lines G₁ₐ-G_{nb} transmitting gate signals (also, referred to as a ‘scanning signal’), and a plurality of data lines D₁-Dₘ transmitting data signals. The gate lines G₁ₐ-G_{nb} extend in an approximately row direction, and are approximately parallel with each other. The data lines D₁-Dₘ extend in an approximately column direction, and are approximately parallel with each other.

Each pixel PX includes a pair of sub pixels, and each sub pixel includes a liquid crystal capacitor Clca and Clcb (as shown in FIG. 2). At least one of two sub pixels includes a switching element (not shown) connected to the gate line, the data line and the liquid crystal capacitor Clca and Clcb.

Two terminals of the liquid crystal capacitors Clca and Clcb are respectively a sub pixel electrode PEa and PEb of the lower display substrate 100, and a common electrode CE of the upper display substrate 200. The liquid crystal layer 3 between the sub pixel electrode PEa and PEB and the common electrode CE functions as a dielectric. The pair of sub pixel electrodes PEa and PEb are divided from each other, and form a single pixel electrode PE. The common electrode CE is formed on all of the surface of the upper display substrate 200, and receives a common voltage Vcom. The liquid crystal layer 3 has a negative dielectric anisotropy, and the major axis of a liquid crystal molecule of the liquid crystal layer 3 may be arranged to be vertical with respect to the surfaces of the two display substrates 100 and 200 when there is no electric field.

To embody a color display, each pixel PX inherently displays one of the primary colors (space division), or each pixel PX alternately displays the primary colors depending on time (time division) to embody a desired color by means of a space synthesis or a time synthesis of the primary colors. The primary colors may include red, green and blue. As shown in FIG. 2, as an example of the space division, each pixel PX includes a color filter CF representing one of the primary colors in an area of the upper display substrate 200. Alternatively, the color filter CF may be formed on or under the sub pixel electrode PEa and PEb of the lower display substrate 100.

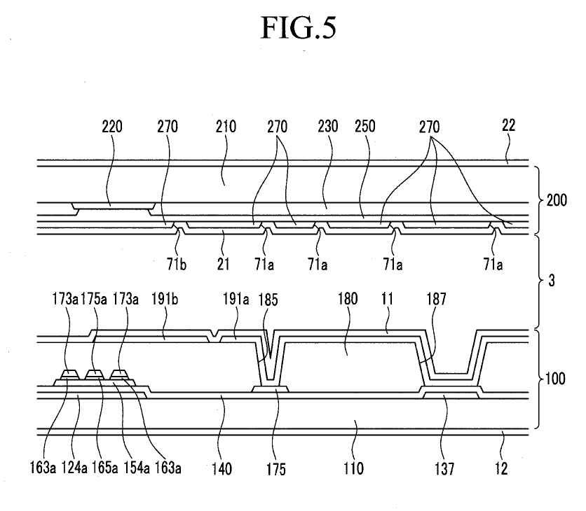

A polarizer (not shown) is provided in an outer surface of the display substrates 100 and 200. Polarizing axes of two polarizers may cross at right angles. In an embodiment using a reflection type liquid crystal display device, one of two polarizers 12 and 22 (shown in FIG. 5) may be omitted. In an embodiment using rectangular polarizers, a light entering the liquid crystal layer 3 without an electric field is blocked.

Referring to FIG. 1 again, the gray scale voltage generating unit 800 generates a plurality of gray scale voltages (or reference gray scale voltage) related to transmittance of the pixel PX.

The gate driving unit 400 is connected to the gate lines G₁ₐ-G_{nb} of the liquid crystal display panel assembly 300 to apply gate signals Vg, each which is formed of a combination of a gate on voltage Von and a gate off voltage Voff to the gate lines.

The data driving unit 500 is connected to the data lines D1-Dm of the liquid crystal display panel assembly 300, and selects the gray scale voltage from the gray scale voltage generating unit 800 to apply to the data line G₁ₐ-G_{nb} as the data signal. However, when the gray scale voltage generating unit 800 supplies just a predetermined number of the reference gray scale voltages instead of supplying all voltages for all gray scales, the data driving unit 500 divides the reference gray scale voltages to generate gray scale voltages for all gray scales, and selects the data signals among these.

The signal control unit 600 controls the gate driving unit 400, the data driving unit 500, and other units as necessary.

Each unit 400, 500, 600 and 800 may be directly mounted on the liquid crystal display panel assembly 300 as a type of (in the form of) at least one integrated circuit chip, or it may be mounted on a flexible printed circuit film (not shown) to be attached to the liquid crystal display panel assembly 300 as a tape carrier package (TCP) type, or it may be mounted on a separate printed circuit board (not shown). Alternatively, the units 400, 500, 600 and 800 may be integrated in the liquid crystal display panel assembly 300. Also, the units 400, 500, 600 and 800 may be integrated as a single chip, and in this case, at least one of these units or at least one circuit element forming these units may be provided outside the single chip.

Hereinafter, as an example of a liquid crystal display panel assembly configuration for one or more embodiments will be described in detail by referring to FIGS. 3 to 8C and FIGS. 1 and 2 described above.

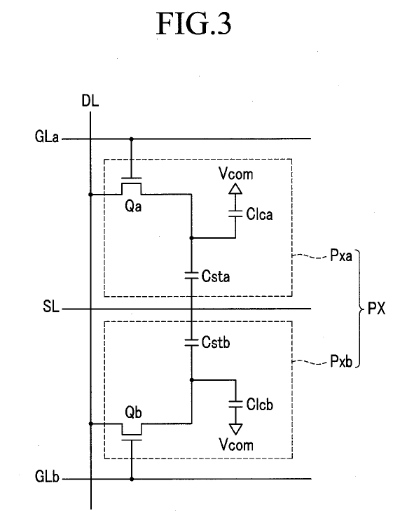

FIG. 3 is an equivalent circuit diagram of a pixel of the liquid crystal display panel assembly according to the exemplary embodiment of the present invention.

As shown in FIG. 3, the liquid crystal display panel assembly according to the present exemplary embodiment includes a plurality of signal lines including plural pairs of gate lines GLa and GLb, a plurality of data lines DL and a plurality of storage electrode lines SL, and a plurality of pixels PX connected thereto.

Each pixel PX includes a pair of sub pixel PXa and PXb, and each sub pixel PXa and PXb includes a switching element Qa and Qb connected to the corresponding gate line GLa and GLb and data line DL, a liquid crystal capacitor Clca and Clcb connected thereto, and a storage capacitor Csta and Cstb connected to the switching element Qa and Qb and the storage electrode line SL.

Each switching element Qa and Qb is a three terminal element such as a thin film transistor provided on the lower display substrate 100. A control terminal thereof is connected with the gate line GLa and GLb, an input terminal thereof is connected with the data line DL, and an output terminal thereof is connected with the liquid crystal capacitor Clca and Clcb and the storage capacitor Csta and Cstb.

The storage capacitor Csta and Cstb supports the liquid crystal capacitor Clca and Clcb. The storage electrode line SL and the pixel electrode PE (labeled in FIG. 2) are overlapped to interpose an insulator therebetween to form the storage capacitor Csta and Cstb, and a predetermined voltage such as a common voltage Vcom is applied to the storage electrode line SL. Alternatively, the sub pixel electrode PEa and PEb may be overlapped with a previous gate line with an insulator therebetween to form the storage capacitor Csta and Cstb.

The liquid crystal capacitors Clca and Clcb may have the same configurations as disclosed above, and therefore, their detailed description is hereby omitted.

In the liquid crystal display that includes this liquid crystal display panel assembly, the signal control unit 600 receives input video signals R, G and B for the pixels PX, converts the input video signals into output video signals DAT for the two sub pixels PXa and PXb and transmits DAT to the data driving unit 500. Alternatively, the gray scale voltage generating unit 800 may separately generate a gray scale voltage group for the two sub pixels PXa and PXb, and alternately supply such gray scale voltage group to the data driving unit 500 or allow the data driving unit 500 to alternately select it, thereby applying different voltages to the two sub pixels PXa and PXb. Here, according to an embodiment, the video signals may be corrected or the gray scale voltage group may be generated so that a synthesized gamma curve of the two sub pixels PXa and PXb can be close to a reference gammacurve in a front view, but this not necessarily limiting. For example, the synthesized gamma curve in a front view is provided to coincide with the reference gamma curve in the front view determined to be most appropriate to the liquid crystal display panel assembly, and the synthesized gamma curve in a side view is provided to be closest to the reference gamma curve in the front view.

Hereinafter, an example of an embodiment of the liquid crystal display panel assembly illustrated in FIG. 3 will be described in detail by referring to FIGS. 4 to 8C, and FIGS. 1 and 2 described above.

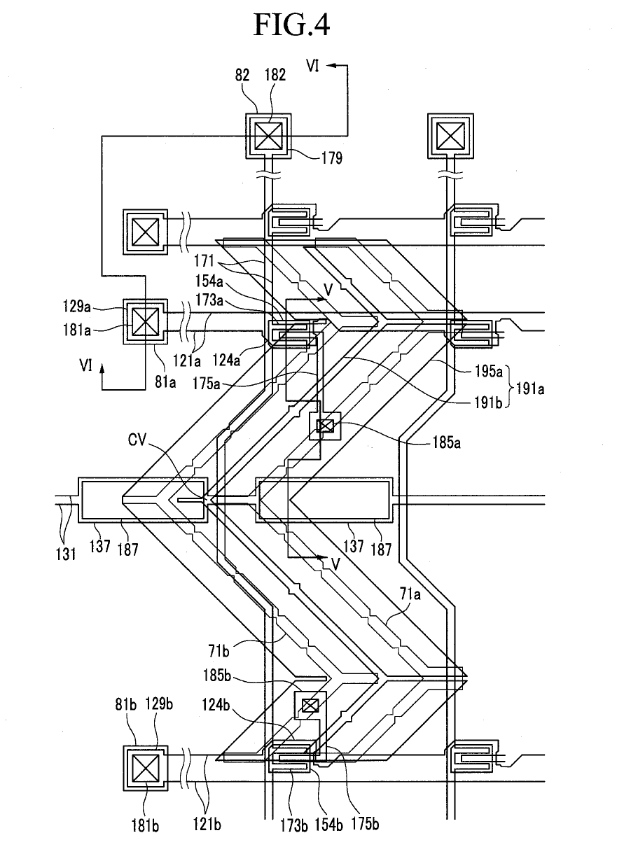

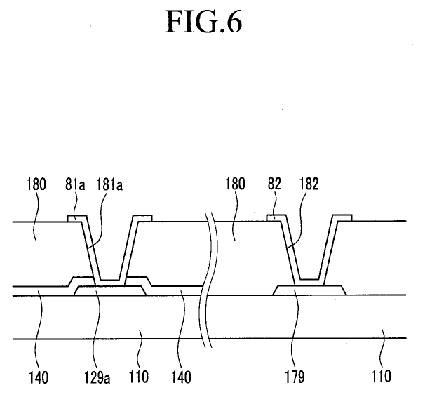

FIG. 4 is an arrangement diagram of the liquid crystal display panel assembly according to the exemplary embodiment of the present invention, and FIGS. 5 and 6 are sectional views of the embodiment of the liquid crystal display panel assembly illustrated in FIG. 4 taken along lines V-V and VI-VI.

As shown in FIGS. 4 to 6, the liquid crystal display panel assembly according to the present embodiment includes the lower display substrate 100 and the upper display substrate 200 facing each other, and the liquid crystal layer 3 interposed between the two display substrates 100 and 200.

At first, the lower display substrate 100 is described.

A gate conductor including plural pairs of first and second gate lines 121a and 121b and a plurality of storage electrode lines 131 is formed on an insulating substrate 110 formed of a transparent glass, plastic, or the like.

The first and second gate lines 121a and 121b transmit gate signals, mainly extend in a widthwise direction, and are respectively positioned in upper and lower sides.

Each of the first gate lines 121a includes a plurality of first gate electrodes 124a protruding upwardly, and a wide end unit 129a for connecting with other layers or with the gate driving unit 400. Each of the second gate lines 121b includes a plurality of second gate electrodes 124b protruding downwardly, and a wide end unit 129b for connecting with other layers or with the gate driving unit 400. When the gate driving unit 400 is integrated on the substrate 110, the gate lines 121a and 121b may extend to directly connect therewith.

Each of the storage electrode lines 131 receives a predetermined voltage such as the common voltage Vcom, and mainly extends in a widthwise direction. Each of the storage electrode lines 131 is respectively positioned between the first gate line 121a and the second gate line 121b. Each storage electrode line 131 includes a plurality of storage electrodes 137 that extend upwardly and downwardly. Alternatively, the shapes and dispositions of the storage electrodes 137 and the storage electrode lines 131 may be changed.

The gate conductor that includes gate lines 121a, 121b and the storage electrode lines 131 may be formed of an aluminum series metal such as aluminum Al, an aluminum alloy, etc., a silver series metal such as silver Ag, a silver alloy, etc., a copper series metal such as copper Cu, a copper alloy, etc., a molybdenum series metal such as molybdenum Mo, a molybdenum alloy, etc., chrome Cr, tantalum Ta, titanium Ti, or the like. Alternatively, the gate conductor that includes gate lines 121a, 121b and storage electrode lines 131 may have a multi layer configuration including two conductive layers (not shown) having different physical properties. One of these conductive layers may be formed of metal having a low resistivity such as an aluminum series metal, a silver series metal, a copper series metal, etc. to reduce a signal delay or a voltage drop. On the other hand, the other conductive layers may be formed of material having good physical, chemical, and electrical contact properties with respect to other materials, such as with respect to indium tin oxide (ITO) and indium zinc oxide (IZO) such as a molybdenum series metal, chrome, tantalum, titanium, etc. As an example for this combination, there may be a chrome lower layer and an aluminum (alloy) upper layer, and an aluminum (alloy) lower layer and a molybdenum (alloy) upper layer. Alternatively, the gate conductor that includes gate lines 121a, 121b and the storage electrode lines 131 may be formed of other various metals and conductive materials.

In an embodiment, sides of the gate conductor that includes gate lines 121a, 121b and the storage electrode line 131 are inclined against a surface of the substrate 110, and the inclined angle thereof is approximately 30° to 80°, but this is not necessarily limiting.

A gate insulating layer 140 formed of silicon nitride SiNx, silicon oxide SiOx or the like may be formed on the gate conductor that includes gate lines 121a, 121b and the storage electrode line 131.

A plurality of first and second island semiconductors 154a and 154b, which may be composed of a hydrogenated amorphous silicon (hereinafter, amorphous silicon may be referred to ‘a-Si’), polysilicon or the like, is formed on the gate insulating layer 140. The first and second island semiconductors 154a and 154b are respectively positioned on the first and second gate electrodes 124a and 124b.

A plurality of island ohmic contacts 163a and 165b (shown in FIG. 5) are formed on the island semiconductors 154a and 154b. The ohmic contacts 163a and 165b may be formed of material such as an n+ hydrogenated amorphous silicon doped with an n-type impurity such as phosphorous with high density, etc. or it may be formed of silicide. The first and second island ohmic contacts 163a and 165b are provided as a pair to be disposed on the island semiconductors 154a and 154b.

Sides of the semiconductor 154a and 154b and the ohmic contacts 163a and 165b are inclined against the substrate 110, and the inclined angle thereof is approximately 30° to 80°.

A data conductor including a plurality of data lines 171 and plural pairs of first and second drain electrodes 175a and 175b is formed on the ohmic contacts 163a and 165b and the gate insulating layer 140.

The data lines 171 transmits data signals, and mainly extend in a lengthwise direction to cross the gate lines 121a and 121b and the storage electrode lines 131. Each data line 171 may not be positioned on a rectilinear line throughout, and may bend at least twice.

Each data line 171 includes plural pairs of first and second source electrodes 173a and 173b respectively extending toward the first and second gate electrodes 124a and 124b, and a wide end unit 179 having a widened area for connecting with other layers or with the data driving unit 500. When the data driving unit 500 is integrated on the substrate 110, the data lines 171 may extend to be directly connected therewith.

The first and second drain electrodes 175a and 175b are separated from each other, and are separated from the data line 171.

The first and second drain electrodes 175a and 175b face the first and second source electrodes 173a and 173b centering on the first and second gate electrodes 124a and 124b, and a rod type end unit thereof is partially surrounded by the bending first and second source electrodes 173a and 173b.

The first and second gate electrodes 124a and 124b, the first and second source electrodes 173a and 173b and the first and second drain electrodes 175a and 175b form first and second thin film transistors (TFT) Qa and Qb together with the first and second semiconductors 154a and 154b. Channels of the first and second thin film transistors Qa and Qb are formed to the first and second semiconductors 154a and 154b between the first and second source electrodes 173a and 173b and the first and second drain electrodes 175a and 175b.

In an embodiment, the data conductor that includes the data lines 171 and the drain electrodes 175a and 175b may be formed of a refractory metal such as molybdenum, chrome, tantalum, etc., or alloys thereof, and may have a multi layer configuration including a refractory metal (not shown) and a low resistance conductive layer (not shown), but this is not necessarily limiting. As an example of the multi layer configuration, there are double layers of a chrome or molybdenum (alloy) lower layer and an aluminum (alloy) upper layer, and triple layers of a molybdenum (alloy) lower layer, an aluminum (alloy) middle layer and a molybdenum (alloy) upper layer. Alternatively, the data conductor that includes the data lines 171 and the drain electrodes 175a and 175b may be formed of other various metals or conductive materials.

In an embodiment, sides of the data conductor that includes the data line 171 and the drain electrodes 175a and 175b are inclined against a surface of the substrate 110 by approximately 30° to 80°, but this not necessarily limiting.

The ohmic contacts 163a and 165a exist only between the semiconductors 154a and 154b and the data conductor that includes the data line 171 and the drain electrodes 175a and 175b, and reduces contact resistance therebetween. In the semiconductors 154a and 154b, there are exposed parts not covered by the data conductor that includes the data line 171 and the drain electrodes 175a and 175b, and ares the intervals between the source electrodes 173a and 173b and the drain electrodes 175a and 175b.

A passivation layer 180 is formed on the data conductor that includes the data line 171 and the drain electrodes 175a and 175b, and on the exposed parts of the semiconductors 154a and 154b. The passivation layer 180 may be formed of, for example, an inorganic insulating material or an organic insulating material, and have a flattened surface. In an embodiment, the organic insulating material has a dielectric constant of less than about 4.0, and may have photosensitivity. Alternatively, the passivation layer 180 may have a double layer configuration of, for example, a lower inorganic layer and an upper organic layer causing no harm to the exposed semiconductors 154a and 154b by using a superior insulating property of the organic layer.

The passivation layer 180 is formed with a plurality of contact holes 182, 185a and 185b respectively exposing the end units 179 of the data lines 171, and the first and second drain electrodes 175a and 175b, and the passivation layer 180 and the gate insulating layer 140 are formed with a plurality of contact holes 181a and 181b respectively exposing the end units 129a and 129b of the gate lines 121a and 121b. Also, the passivation layer 180 is formed with opening units 187 respectively exposing parts of the storage electrode 137.

A plurality of pixel electrodes 191 and a plurality of contact assistants 81a, 81b and 82 are formed on the passivation layer 180. These may be formed of a transparent conductive material(s) and a reflective metal such as aluminum, silver, chrome, alloy thereof, etc.

Each pixel electrode 191 includes a pair of first and second sub pixel electrodes 191a and 191b which are separated from each other.

Each first sub pixel electrode 191a is respectively connected with each drain electrode 175a through the contact hole 185a, and each second sub pixel electrode 191b is respectively connected with each second drain electrode 175b through the contact hole 185b.

The pixel electrodes 191 are overlapped to interpose the data lines 171 and the passivation layer 180 therebetween.

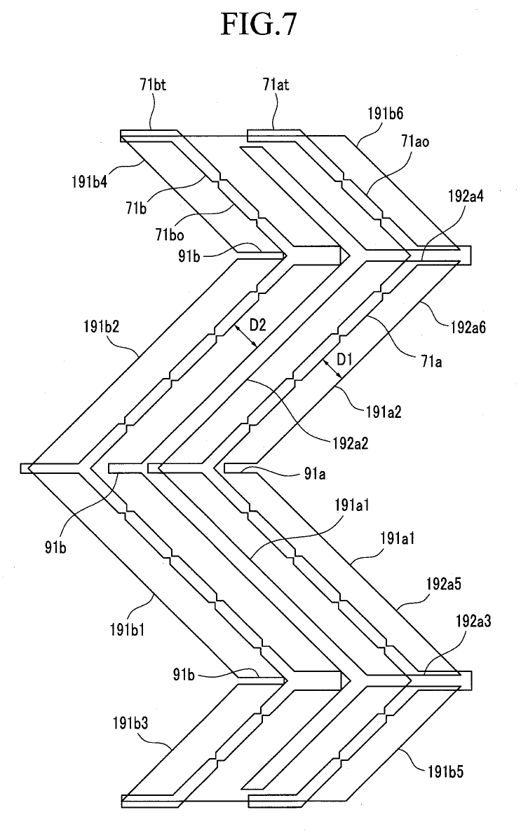

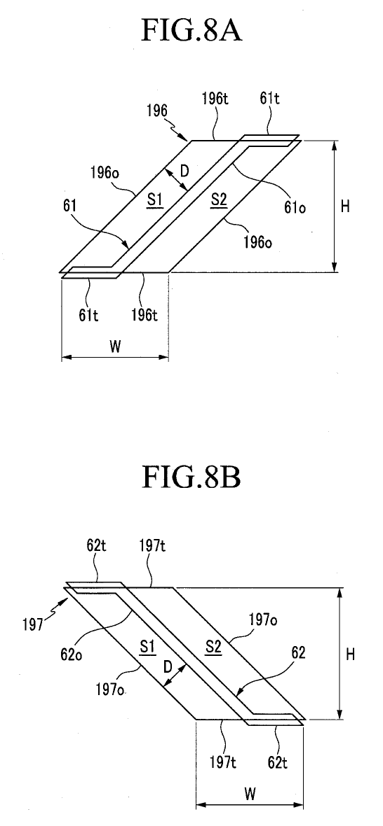

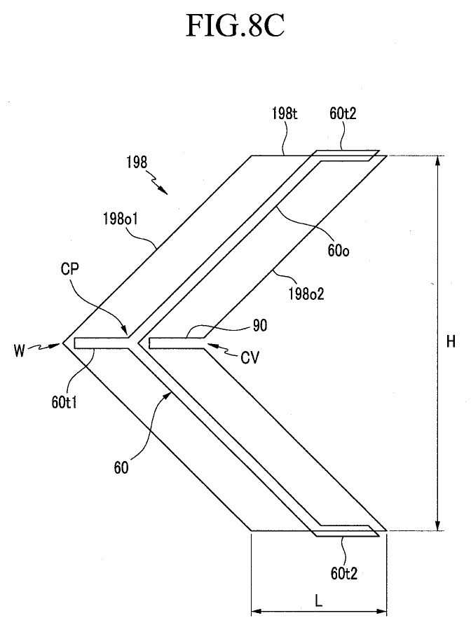

Hereinafter, an embodiment of a configuration of the pixel electrode 191 of the liquid crystal display panel assembly will be described by referring to FIGS. 7, 8A, 8B and 8C in detail.

FIG. 7 is a schematic arrangement diagram of a single pixel electrode of the liquid crystal display panel assembly according to various exemplary embodiments of the present invention, and FIGS. 8A to 8C are plane views of an electrode piece which is a basis of each sub pixel electrode according to the embodiment illustrated in FIG. 7.

As shown in FIG. 7, each pixel electrode 191 of the liquid crystal display panel assembly according to the present exemplary embodiment includes a pair of first and second sub pixel electrodes 191a and 191b (also illustrated in FIG. 4), which are separated from each other. The first sub pixel electrode 191a and the second sub pixel electrode 191b are adjacent to each other in a row direction, and include a cutout 91a and 91b. The common electrode CE referring to FIG. 2 (and also shown as reference numeral 270 in FIG. 5), includes cutouts 91a and 91b facing the first and second sub pixel electrodes 191a and 191b.

The first and second sub pixel electrodes 191a and 191b respectively may include at least one electrode piece 196 having a parallelogram shape illustrated in FIG. 8A, and at least one electrode piece 197 having a parallelogram shape illustrated in FIG. 8B. The electrode pieces 196 and 197 are connected up and down to form a basic electrode 198 illustrated in FIG. 8C. Each sub pixel electrode 191a and 191b has a configuration, a foundation of which employs the basic electrode 198.

As shown in FIGS. 8A and 8B, each electrode piece 196 and 197 includes a pair of oblique edges 196o and 197o, and a pair of transverse edge 196t and 197t, and may have an approximately parallelogram shape. Each oblique edge 196o and 197o forms an oblique angle against the transverse edges 196t and 197t, and according to an embodiment, the oblique angle is approximately 45 degrees to 135 degrees, but this is not necessarily limiting. Also, each oblique edge is coupled with an oblique of another electrode piece to have a groove having a concave or convex shape for forming a notch having a concave or convex shape. Furthermore, for convenience, the electrode piece 196 and 197 is classified depending on an inclined direction (referred to ‘inclination direction’) when being in a vertical state with respect to the oblique edge 196t and 197t. A case of inclining right is referred to as ‘right inclination’ as shown in FIG. 8A, and a case of inclining left is referred to as ‘left inclination’ as shown in FIG. 8B.

The length of the transverse edge 196t and 197t in the electrode piece 196 and 197, that is, the width “W”, and the distance between the transverse edges 196t and 197t, that is, the height “H” may be freely determined depending on the size of the display panel assembly 300. Also, the transverse edge 196t and 197t in each electrode piece 196 and 197 may bend, protrude or be variously transformed, and hereinafter, the parallelogram shape may include these transformations.

The common electrode 270 is formed with cutouts 61 and 62 (as shown in FIG. 8B) facing the electrode pieces 196 and 197. The electrode pieces 196 and 197 are partitioned into two sub areas S1 and S2 centering on the cutouts 61 and 62. The cutouts 61 and 62 may be formed with at least one notch. The cutouts 61 and 62 include oblique units 61o and 62o which are in parallel with the oblique edges 196o and 197o, and transverse units 61t and 62t form an obtuse angle against the oblique units 61o and 62o to be overlapped with the transverse edges 196t and 197t of the electrode pieces 196 and 197.

According to an embodiment, for each sub areas S1 and S2, the width, which is defined as the distance between the oblique units 61o and 62o of the cutouts 61 and 62 and the oblique edges 196t and 197t of the electrode pieces 196 and 197, is approximately 15 μm to 40 μm, but this is not necessarily limiting.

A right inclination electrode piece 196 and a left inclination electrode piece 197 are coupled to form the basic electrode 198 illustrated in FIG. 8C. According to an embodiment, an angle between the right inclination electrode piece 196 and the left inclination electrode piece 197 is approximately a right angle, and two electrode pieces 196 and 197 are connected in a part thereof. A part which is not connected forms a cutout 90, and is positioned to a concave side. Alternatively, the cutout 90 may be omitted.

The transverse edges 196t and 197t of outer sides of the two electrode pieces 196 and 197 facing each other form a transverse edge 198t of the basic electrode 198, and the corresponding oblique edges 196o and 197o of the two electrode pieces 196 and 197 are connected with each other to form curved edges 198o1 and 198o2 of the basic electrode 198.

The curved edge 198o1 is on a convex side and meets the transverse edge 198t to form an obtuse angle, for example, approximately 135° therebetween, and the curved edge 198o2, which is on a concave side, meets the transverse edge 198t to form an acute angle, for example, approximately 45°. Since the pair of oblique edges 196o and 197o meet in an approximately right angle to form the curved edge 198o1 and 198o2, a bending angle thereof is an approximately right angle.

A cutout 60 of the common electrode is distanced from the curved edge 198o2 on the concave side of the electrode piece such that it is formed to be similar to the shape of the concave edge. The cutouts 61 and 62 of the common electrode 270 are connected to each other to form the single cutout 60. Here, the transverse units 61t and 62t overlap in the cutouts 61 and 62 and are merged to form a single transverse unit 60t1. This new cutout 60 is described as follows.

The cutout 60 includes a curved unit 60o having a curved point CP, a central transverse unit connected to the curved point CP of the curved unit 60o, and a pair of vertical transverse units 60t2 connected to the opposite end parts of the curved unit 60o. The curved unit 60o of the cutout 60 is made up of a pair of oblique units meeting in a right angle, it is approximately in parallel with the curved edges 198o1 and 198o2 of the basic electrode 198, and equally divides the basic electrode 198 into a left half and a right half. The central transverse unit 60t1 of the cutout 60 forms an obtuse angle, for example, approximately 135° against the curved unit 60o, and extends approximately toward a convex vertex VV of the basic electrode 198. The vertical transverse unit 60t2 is aligned with respect to the transverse edge 198t of the basic electrode 198, and forms an obtuse angle, for example, 135° against the curved unit 60o.

The basic electrode 198 and the cutout 60 are approximately reverse-symmetrical with respect to an imaginary straight line (hereinafter, referred to as ‘transverse central line’) connecting the convex vertex VV and a concave vertex CV of the basic electrode 198.

The cutout 60 may include at least one notch for preventing a texture generated due to disordered alignments of the liquid crystal molecules from being spread into the pixel areas. The notch may have concave or convex shapes, and the number of notches formed to the oblique unit 60o of the cutout may vary depending on the width and height of two electrode pieces 197 and 198.

In each pixel electrode 191 illustrated in FIG. 7, the area of the first sub pixel electrode 191a is smaller than the area of the second sub pixel electrode 191b. The area ratio of the first sub pixel electrode 191a and the second sub pixel electrode 191b may be approximately 1:1.5 to 1:2.5, and in some embodiments, may approach approximately 1:2. Also, the height of the second sub pixel electrode 191b is bigger than the height of the first sub pixel electrode 191a, and the widths of the two sub pixel electrodes 191a and 191b may be substantially the same. The number of the electrode pieces of the second sub pixel electrode 191b is bigger than the number of the electrode pieces of the first sub pixel electrode 191a.

Hereinafter, the present exemplary embodiment of the present invention will be described more in detail by referring to FIG. 7. The first sub pixel electrode 191a (shown in FIG. 4) is made up of the left inclination electrode piece 197 (shown in FIG. 8B) and the right inclination electrode piece 196 (shown in FIG. 8A), and has a configuration similar to the basic electrode 198 illustrated in FIG. 8C. The first sub pixel electrode 191a includes a first oblique edge 192a1 and a second oblique edge 192a2. A concave notch may be formed along each oblique edge. The first sub pixel electrode 191a includes a first transverse edge 192a3 and a second transverse edge 192a4 respectively connected with the first oblique edge 192a1 and the second oblique edge 192a2. A third oblique edge 192a5 and a fourth oblique edge 192a6 are respectively in parallel with the first oblique edge 192a1 and the second oblique edge 192a2.

The second sub pixel electrode 191b is made up of more than two left inclination electrode pieces 197 and more than two right inclination electrode pieces 196, and includes the basic electrode 198 illustrated in FIG. 8C, and the left inclination and right inclination electrode pieces 196 and 197 coupled thereto.

The second sub pixel electrode 191b is made up of six electrode pieces 191b1 to 191b6 (shown in FIG. 7), of which two electrode pieces, 191b5 and 191b6, are disposed on upper and lower sides of the first sub pixel electrode 191a. The pixel electrode 191b has a three-times bending configuration, and has a superior vertical line presentation than a once bending configuration. Also, since the transverse units 61t and 62t of the cutouts 61 and 62 (shown respectively in FIGS. 8A and 8B) of the common electrode 270 illustrated in FIG. 8C are merged at a position to which the electrode pieces 191a1 and 191a2 of the first sub pixel electrode 191a, and the electrode pieces 191b5 and 191b6 of the second sub pixel electrode 191b are adjacent to make up a single transverse unit, the aperture ratio can further increase.

The middle electrode pieces 191a1, 191a2, 191b1 and 191b2, and the electrode pieces 191b3 to 191b6 disposed on the upper and lower sides thereof have different heights. For example, the height of the upper and lower electrode pieces 191b3 to 191b6 is approximately ½ of that of the middle electrode pieces 191a1, 191a2, 191b1 and 191b2, and accordingly, the area ratio of the first sub pixel electrode 191a and the second sub pixel electrode 191b becomes approximately 1:2. Likewise, the height of the upper and lower electrode pieces 191b2 to 191b6 may be adjusted to obtain a desired area ratio.

In FIG. 7, the number, position relation and bending direction of the first and second sub pixel electrodes 191a and 191b may be changed. The pixel electrode 191 in FIG. 7 may be reversely and symmetrically moved up and down and right and left, or it may be rotated.

As shown in FIG. 7, cutouts 71a and 71b of the common electrode 270 includes oblique units 71ao and 71bo of the cutout substantially parallel with the oblique edge of each sub pixel electrode 191a and 191b, and transverse units 71at and 71bt connected with the oblique units 71ao and 71bo and substantially parallel with the transverse edge of each sub pixel electrode 191a and 191b. The oblique units 71ao and 71bo of the cutout may be formed with a convex notch.

In FIG. 7, the first sub pixel electrode 191a and the second sub pixel electrode 191b may be divided into a plurality of sub areas by means of a second domain dividing means, and the width of each sub area may be the same or different. The second domain dividing means may be a cutout of the common electrode 270 formed to the upper display substrate 200, or a protrusion formed of dielectric material. A sub area width of the first sub pixel electrode 191a and the second sub pixel electrode 191b, that is, the distance “D” of the domain dividing means is defined as the distance between the oblique unit 61o and 62o of the cutout 61 and 62, and the oblique edge 196t and 197t of the electrode piece 196 and 197 (shown respectively in FIGS. 8A and 8B), and may be, according to an embodiment, approximately 15 μm-40 μm.

In the conventional configuration, the sub area width is restrictedly designed within about 24 μm because the aperture ratio increases, but the response speed of the liquid crystal molecules considerably increases in a sub area middle position when the distance of the domain dividing means increases. On the other hand, when the sub area width decreases, the aperture ratio decreases, but the response speed is improved. That is, the aperture ratio and the response speed have a trade off relationship depending on the increase and decrease of the sub area width.

As an exemplary embodiment of the present invention, in designing the sub pixel area having a sub area width of more than about 28 μm, a chiral dopant is added to a liquid crystal composition to improve the response speed and the aperture ratio. Also, in FIG. 7, sub areas of the first sub pixel electrode 191a and the second sub pixel electrode 191b to which different voltages are applied have different widths to improve a motion blur to enhance a display quality when a low gray scale voltage is applied to the pixel electrode 191.

In FIG. 7, when the sub area width divided by means of the cutout of the first sub pixel electrode 191a and the common electrode 270, referred to as “D1,” and the sub area width divided by means of the cutout of the second sub pixel electrode 191b and the common electrode 270, referred to as “D2,” the ratio of the sub area width of the first sub pixel electrode 191a and the second sub pixel electrode 191b may be approximately 1:1.2 to 1:2.7. Also, according to an embodiment, to improve the display quality, “D1” may be approximately 15 μm-24 μm, and “D2” may be approximately 28 μm-40 μm.

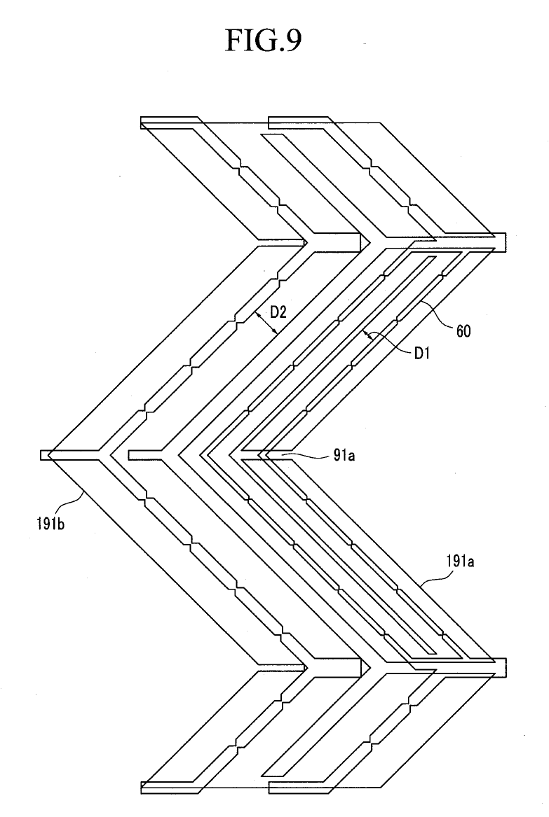

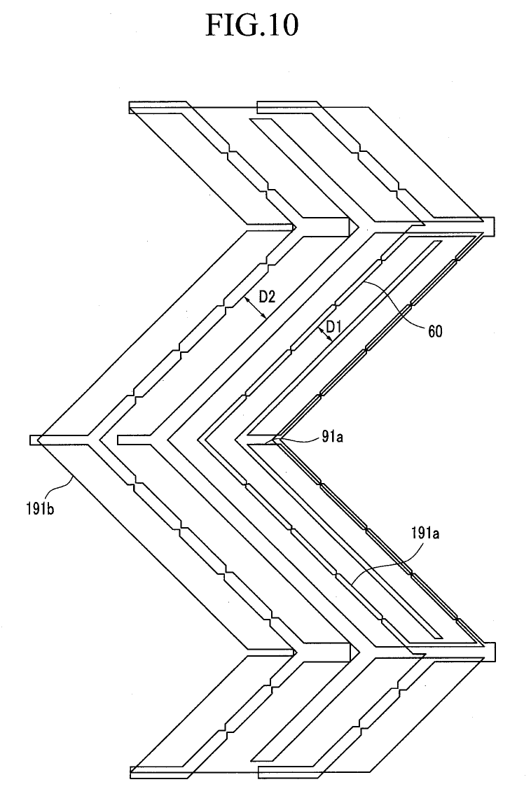

In FIGS. 9 and 10, as an exemplary embodiment of the present invention, the ratio of “D1” and “D2” is respectively about 1:2 and about 1:1.5. In FIGS. 9 and 10, the area ratio of the first sub pixel electrode 191a and the second sub pixel electrode 191b may be about 1:2.

At first, referring to FIG. 9, the distance “D1” between the domain dividing means in the first sub pixel electrode 191a is approximately 0.5 times of the distance “D2” between the domain dividing means in the second sub pixel electrode 191b. Unlike in FIG. 7, the cutout 60 of the common electrode is provided in two lines on the first sub pixel electrode 191a, and the cutout 91a of the pixel electrode is elongated in a lengthwise direction of the first sub pixel electrode 191a.

Referring to FIG. 10, the distance “D1” between the domain dividing means in the first sub pixel electrode 191a is approximately ⅔ of the distance “D2” between the domain dividing means in the second sub pixel electrode 191b. Unlike in FIG. 7, the cutout 60 of the common electrode is provided in two lines on the first sub pixel electrode 191a, and one thereof extends along an outer edge of the first sub pixel electrode 191a. The cutout 91a of the pixel electrode is elongated along the lengthwise direction of the first sub pixel electrode 191a.

In FIGS. 9 and 10, the distance between the domain dividing means dividing the first sub pixel electrode 191a may be uniform, and the distance between the domain dividing means dividing the second sub pixel electrode 191b may be uniform.

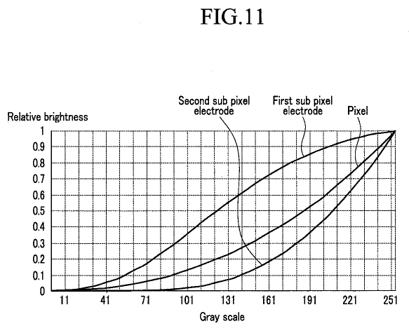

FIG. 11 is a gamma curve property of each gray scale voltage of the first sub pixel electrode and the second sub pixel electrode having a uniform area ratio, and receiving different voltages. As shown in FIG. 11, a voltage is applied to only the first sub pixel electrode to which a higher voltage is applied than the second sub pixel electrode up to 96G (gray levels). The second sub pixel electrode has no effect on brightness of a pixel area under 96G. In replaying a motion picture needing a rapid processing of an image information, a motion blur generally appears when a low gray scale voltage is applied to the pixel electrode. Accordingly, a high voltage is designed to be applied to the first sub pixel electrode which is higher than the second sub pixel electrode in a low gray scale section, thereby improving the motion blur.

As an exemplary embodiment of the present invention, the type of the cutout of the pixel electrode and the common electrode may be varied. The relation between the sub area width of the first sub pixel electrode and the second sub pixel electrode may be applied to any liquid crystal display in which the first and second sub pixel electrodes are distanced from each other, and different voltages are applied thereto. For example, this may be applied to a configuration in which the first sub pixel electrode and the second sub pixel electrode form a capacitive coupling to form a different voltage when applying specific data voltages through the data lines.

Referring to FIGS. 4 to 7 again, the first and second sub pixel electrodes 191a and 191b and the common electrode 270 of the upper display substrate 200 respectively form the first and second liquid crystal capacitors Clca and Clcb together with parts of the liquid crystal layer 3 therebetween to maintain applied voltages after the thin film transistors Qa and Qb are turned off.

The first and second sub pixel electrodes 191a and 191b are overlapped with the storage electrode 137 to interpose the gate insulating layer 140 therebetween to respectively form the first and second storage capacitors Csta and Cstb. The first and second storage capacitors Csta and Cstb reinforce a voltage maintaining ability of the first and second liquid crystal capacitors Clca and Clcb. Here, since the passivation layer 180 is formed with the opening units 187, only the gate insulating layer 140 exists between the pixel electrode 191 and the storage electrode 137, and the distance between the pixel electrode 191 and the storage electrode line 131 decreases, thereby improving the voltage maintaining ability.

The contact assistants 81a, 81b and 82 are connected with the end parts of the gate lines 121a and 121b, and the end parts of the data line 171 through the contact holes 181a, 181b and 182. The contact assistants 81a, 81b and 82 compensate an adhesive property of the end parts 129a and 129b of the gate lines 121a and 121b and the end parts 179 of the data line 171 against an external device, and protects these. Next, the upper display substrate 200 will be described.

A light blocking member 220 (shown in FIG. 5) is formed on an insulating substrate 210 made of a transparent glass, plastic, or the like. The light blocking member 220 includes curved units corresponding to the curved edges of the pixel electrodes 191, and rectangular parts corresponding to the thin film transistors. The light blocking member 220 prevents light leakage between the pixel electrodes 191 and defines opening areas facing the pixel electrodes 191.

A plurality of color filters 230 are formed on the substrate 210 and the light blocking member 220. The color filters 230 exist in most of areas which are surrounded by the light blocking member 230, and may be elongated along the column of the pixel electrodes 191. Each color filter 230 may display one of the primary colors such as primary colors red, green and blue.

An overcoat 250 is formed on the color filters 230 and the light blocking member 220. The overcoat 250 may be formed of an (organic) insulating material, and prevents the color filters 230 from being exposed, and provides a planar surface. The overcoat 250 may be omitted.

The common electrode 270 is formed on the overcoat 250.

A plurality of cutouts 71a and 71b are formed on the common electrode 270. The description of the cutouts 71a and 71b is as described above.

Alignment layers 11 and 21 are formed on inner surfaces of the display substrates 100 and 200, and these may be a vertical alignment layer.

The polarizers 12 and 22 are provided on the outer surfaces of the display substrates 100 and 200. Polarizing axes of the two polarizers 12 and 22 meet at right angles, and according to an embodiment, one of these polarizing axes is in parallel with the gate line 121a and 121b, but this is not necessarily limiting. In a reflecting type liquid crystal display device, one of the two polarizers 12 and 22 may be omitted.

The liquid crystal display may include a backlight unit (not shown) supplying a light to the polarizers 12 and 22, a phase retarding layer, the display substrates 100 and 200 and the liquid crystal layer 3.

The liquid crystal layer 3 has a negative dielectric anisotropy, and the liquid crystal molecules of the liquid crystal layer 3 are aligned so that the major axis thereof can be vertical to surfaces of the two display substrates when there is no electric field.

The liquid crystal layer 3 according to the present exemplary embodiment includes a chiral dopant. An inclined direction of the liquid crystal molecular is determined depending on chirality of the chiral dopant. If the amount of the chiral dopant increases, a pitch of the liquid crystal molecule is small so that the modulus of elasticity can increase, and a restoration force can increase. When the restoration force increases, the response time is shortened, thereby improving the display quality of the liquid crystal display.

In an exemplary embodiment of the present invention, the pitch of the liquid crystal molecular including the chiral dopant may, but not necessarily, be more than about 20 μm and may be used when the sub area width is more than about 20 μm. In another embodiment, the pitch of the liquid crystal molecular including the chiral dopant may be more than about 40 μm and may be used when the sub area width is less than about 20 μm.

Hereinafter, an example of the operation of the liquid crystal display according to one or more embodiments will be described in detail.

As shown in FIG. 1, the signal control unit 600 receives input video signals R, G and B and input control signals controlling a display thereof from an external graphic controller (not shown). The signal control unit 600 then processes this appropriately for an operation condition of the liquid crystal display panel assembly 300. The signal control unit 600 then generates a gate control signal CONT1, a data control signal CONT2, etc., and transmits this to the gate driving unit 400 and the data driving unit 500.

The gate driving unit 400 applies the gate on voltages Von to the gate lines G₁-Gₙ depending on the gate control signal CONT1 from the signal control unit 600 to turn on the switching elements Q connected to the gate lines G₁-Gₙ. Then, the data signals applied to the data lines D₁-Dₘ are applied to the corresponding pixels PX through the turned on switching elements Q.

Here, since the first sub pixel electrode 191a and the second sub pixel electrode 191b composing the single pixel electrode 191 are connected with separate switching elements, the two sub pixels receive separate data voltages through the same data line in different times. Alternatively, the first sub pixel electrode 191a and the second sub pixel electrode 191b may be connected with separate switching elements, and may receive separate data voltages through different data lines at the same time. Also, when the first sub pixel electrode 191a is connected with a switching element (not shown), and the second sub pixel electrode 191b is capacitively connected with the first sub pixel electrode 191a, only the sub pixel including the first sub pixel electrode 191a receives the data voltage through the switching element, and the sub pixel including the second sub pixel electrode 191b may have a voltage varying depending on a voltage variation of the first sub pixel electrode 191a. Here, the voltage of the first sub pixel electrode 191a which has a relatively small area is larger than the voltage of the second sub pixel electrode 191b which has a relatively large area.

The difference between the voltage of the data signal applied to the pixel PX and the common voltage Vcom appears as a charged voltage of the liquid crystal capacitor Clc, that is, the pixel voltage. The liquid crystal molecules have an alignment varying depending on the level of the pixel voltage, and accordingly, polarization of a light transmitting the liquid crystal layer 3 varies. This polarization variation appears as a transmittance variation of the light by means of the polarizer attached to the display panel assembly 300, and the pixel PX displays brightness which gray scales of video signals DAT represents therethrough.

An inclined angle of the liquid crystal molecules varies depending on the intensity of the electrical field. Since the voltage of the two liquid crystal capacitors Clca and Clcb are different, the inclined angle of the liquid crystal molecules is different so that the brightness of the two sub pixels can be different. Accordingly, when the voltage of the first liquid crystal capacitor Clca and the voltage of the second liquid crystal capacitor Clcb are appropriately adjusted, video which is viewed from a side can be extremely similar to video which is viewed from the front, that is, a side gamma curve can be extremely similar to a front gamma curve, thereby improving side visibility.

Also, when the area of the first sub pixel electrode 191a receiving a high voltage is smaller than the area of the second sub pixel electrode 191b, the side gamma curve can be even more similar to the front gamma curve. In an embodiment, when the area ratio of the first and second sub pixel electrodes 191a and 191b is approximately 1:2 to 1:3, the side gamma curve can be even more similar to the front gamma curve, thereby improving side visibility.

According to embodiments of the present invention, an interval of a domain dividing means of a sub pixel to which different voltages are applied, and a chiral dopant pitch, are adjusted to improve transmittance and a response speed of a liquid crystal display, and to reduce a motion blur in replaying a motion picture.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A liquid crystal display, comprising:
a first substrate;
a pixel electrode, which is formed on the first substrate, comprises a first domain dividing means, a first sub pixel electrode and a second sub pixel electrode which are distanced from each other to have a predetermined interval;
a second substrate which is disposed to face the first substrate;
a second domain dividing means which is formed on the second substrate; and
a liquid crystal layer which is interposed between the first substrate and the second substrate,
wherein a plurality of sub areas is defined by the first and second domain dividing means, and a width of a sub area of the first sub pixel electrode and a width of a sub area of the second sub pixel electrode are different.

2. The liquid crystal display of claim 1, wherein the liquid crystal layer comprises a chiral dopant.

3. The liquid crystal display of claim 2, wherein a pitch of a liquid crystal molecular which comprises the chiral dopant is more than about 20 μm.

4. The liquid crystal display of claim 1, wherein different data voltages are applied to the first sub pixel electrode and the second sub pixel electrode.

5. The liquid crystal display of claim 4, wherein a higher data voltage is applied to the first sub pixel electrode than the second sub pixel electrode.

6. The liquid crystal display of claim 5, further comprising:
a first gate line and a second gate line which are formed on the first substrate adjacent to each other;
a data line which is insulated from the first gate line and the second gate line, and crosses the first gate line and the second gate line; and
a first thin film transistor to which the first gate line and the data line are electrically connected, and a second thin film transistor to which the second gate line and the data line are electrically connected,
wherein a time-divided gate on voltage is applied to the first gate line and the second gate line.

7. The liquid crystal display of claim 5, further comprising:
a gate line which is formed on the first substrate;
a first data line and a second data line which are insulated from the gate line, cross the gate line, and are adjacent to each other; and
a first thin film transistor to which the gate line and the first data line are electrically connected, and a second thin film transistor to which the gate line and the second data line are electrically connected,
wherein different data voltages are applied to the first and second data lines when a gate on voltage is applied to the gate line.

8. The liquid crystal display of claim 5, wherein the first sub pixel electrode and the second sub pixel electrode form a capacitive coupling.

9. The liquid crystal display of claim 1, wherein the width of the sub area of the first sub pixel electrode is smaller than the width of the sub area of the second sub pixel electrode.

10. The liquid crystal display of claim 9, wherein a width ratio of the first sub pixel electrode and the second sub pixel electrode is approximately 1:1.2 to 1:2.7.

11. The liquid crystal display of claim 10, wherein a width of the first sub pixel electrode is approximately 15 to 24 μm.

12. The liquid crystal display of claim 10, wherein a width of the second sub pixel electrode is approximately 28 to 40 μm.

13. The liquid crystal display of claim 11, wherein a pitch of a liquid crystal molecular which comprises a chiral dopant is more than approximately 20 μm when the width of the sub area of the first sub pixel electrode is more than approximately 20 μm.

14. The liquid crystal display of claim 11, wherein a pitch of a liquid crystal molecular which comprises a chiral dopant is more than approximately 40 μm when the width of the sub area of the first sub pixel electrode is less than approximately 20 μm.

15. The liquid crystal display of claim 1, wherein the sub area of the second sub pixel electrode is bigger than the sub area of the first sub pixel electrode.

16. The liquid crystal display of claim 15, wherein a ratio of the sub area of the first sub pixel electrode and the sub area of the second sub pixel electrode is approximately 1:1.5 to 1:2.5.
